(19) United States
(12) Patent Application Publication
(10) Pub. No.: US 2021/0130063 A1
(43) Pub. Date: May 6, 2021

(54) METHOD OF PACKAGING AN EDIBLE PRODUCT AND A UNIT OF PACKAGED PRODUCT

(71) Applicants: Moreno MONTI, Monteveglio (BO) (IT); Massimiliano PARINI, Alberone di Cento (FE) (IT)

(72) Inventors: Moreno MONTI, Monteveglio (BO) (IT); Massimiliano PARINI, Alberone di Cento (FE) (IT)

(21) Appl. No.: 17/090,431

(22) Filed: Nov. 5, 2020

(30) Foreign Application Priority Data
Nov. 6, 2019 (IT) 102019000020482

(51) Int. Cl. B65D 75/56; B65B 3/02; B65B 3/04; B65B 7/16; B65B 25/00; B65D 85/78; B65D 75/20

(52) U.S. Cl. CPC B65D 75/56; B65B 3/022; B65B 3/04; B65D 2575/56; B65B 25/007; B65D 85/78; B65D 75/20; B65B 7/16

(57) ABSTRACT

A method for packaging an edible product, includes forming a package with a pouch portion and a pocket portion which communicate through a passage. A handle is inserted through the passage which is then tightly sealed around the handle to avoid any leak between the pouch portion and the pocket portion. The pouch portion is then filled with an edible to make a packaged edible product with a handle.

### CROSS-REFERENCE TO RELATED APPLICATIONS

This claims priority from Italian Application No. 102019000020482, filed Nov. 6, 2019, the disclosure of which is hereby incorporated by reference in its entirety.

### FIELD OF INVENTION

This invention concerns a method of packaging an edible product. The invention also concerns a unit of a packaged edible product.

The packaging method can be used to give a desired shape to food products such as ice cream, an ice-cold drink, sweets, cheese, by pouring, or injecting, a syrup, or in general a fluid mixture, in a mould, and with its subsequent solidification.

The invention was developed with particular attention to the packaging of an edible product with an insert or handle to allow the product to be kept while it is being consumed.

### BACKGROUND

The known technique includes methods of forming edible products which include the pouring of a mixture, be it a syrup, liquid or paste, into a mould with its subsequent solidification by cooling. In those cases where the finished products contain an insert, in the form of a stick or handle to allow the product to be held while it is being consumed, as in the case of ice cream or popsicles for example, the insert is placed in the mould, generally during or after the pouring of the mixture and always before its final solidification. Solutions of this type are for example described in the documents of the prior art U.S. Pat. Nos. 2,759,831, 4,001,440 and WO 93/21087.

The positioning of the insert is not easy, in particular because it requires complex mechanisms to hang the insert in the cavity of each mould. Moreover, often during casting the portion of the insert protruding from the product is covered with a little liquid or syrup mixture, causing an unpleasant and unhygienic contact of the product with the hand holding the insert while the product is being consumed.

Document WO 95/05749 of the same applicant describes a process in which a pack is formed with a pouch portion and a tubular portion communicating with each other, with a handle extending along the tubular portion and from there into the pouch portion. The pouch portion is filled with an edible fluid through an opening in the pack, which is then sealed. The special feature of this solution is that the handle is inserted into the tubular portion after forming the tubular portion but before filling the pouch portion.

The solution described in WO 95/05749 has proved satisfactory in solving the problems of the known technique related to the correct positioning of the insert or handle. However, this solution is only effective in the case of inserts that have a regular shape, without undercuts and for example cylindrical, of the handle portion that is inserted into the tubular portion in the packaging. As there is an increasing need in the packaged product sector to customise the handle portion of the insert, the need has arisen to provide a solution that allows the limits of the known technique to be overcome.

In the method described in WO 95/05749, a problem is also encountered for the manufacture of packaged products with flat inserts of the stick or slat type. In order to avoid that during casting the portion of the insert protruding from the product is covered with a little liquid mixture, WO 95/05749 teaches how to make a sealing ring on the stick. This solution effectively limits the flexibility in the manufacture of sticks and associated packaging by requiring the manufacturer to adopt a specific insert configuration that includes the sealing ring, which is not always feasible or acceptable to the consumer.

### SUMMARY OF THE INVENTION

One purpose of this invention is to provide a method for packaging edible products with an insert of any shape. Another purpose of the invention is to provide a product packaged with an insert of any shape.

Within these purposes, the objective of making a packaged product that can use a flat or thin insert without the risk of the product covering part of the handle portion of the insert or handle is particularly important.

According to one aspect, a packaging process of an edible product is described in which a package comprising a pouch portion and a pocket portion is formed. Between these two portions of the package, that is the pouch portion and the pocket portion, a passage is formed in which an insert or handle is inserted, so that it is arranged with an anchoring portion in the pocket portion of the package, and with another a grip portion into the pouch portion of the package. The method involves tightly sealing the package around the insert or handle in an area substantially at, or adjacent to the passage where the insert is inserted. In this way a tight seal is obtained between the pouch portion and the pocket portion, substantially narrowing the passage around the insert. The method then involves filling the pouch portion of the package with an edible fluid through an opening in the package, which is then welded and/or sealed when the filling is complete.

In a preferred aspect, the package is sealed around an intermediate portion of the handle, that is, a portion between the anchor portion and the grip or handle portion.

According to another preferred aspect, the package is formed by joining together a pair of opposing shells, preferably of plastic material. The sealing around the handle is preferably carried out by hot compressing the two shells by means of a mould. The two opposing shells are preferably sealed together in a separable way along a peripheral edge. It is possible to form the pouch portion and the pocket portion by blowing moulding.

According to another aspect, a packaged product unit including a package is described. The package includes a pouch portion and a pocket portion. Between the pouch portion and the pocket portion there is a passage through which an insert or handle is disposed. The insert or handle is placed partially in the pocket portion and partially in the pouch portion. An edible product is placed in the pouch portion. At or near the passageway, the package is sealed around the insert or handle to provide a seal between the pouch portion and the pocket portion.

### BRIEF DESCRIPTION OF THE DRAWINGS

Further features and advantages will result from the following detailed description of a preferred embodiment, with reference to the attached drawings, given as a non-limiting example:

FIG. 1 is a perspective view of a packaged product unit incorporating features of the present invention;

FIG. 2 is a cross-section of the packaged product unit according to the plane II-II of FIG. 1; and

FIG. 3 is a longitudinal section of the packaged product unit according to line III-III of FIG. 2.

### DETAILED DESCRIPTION

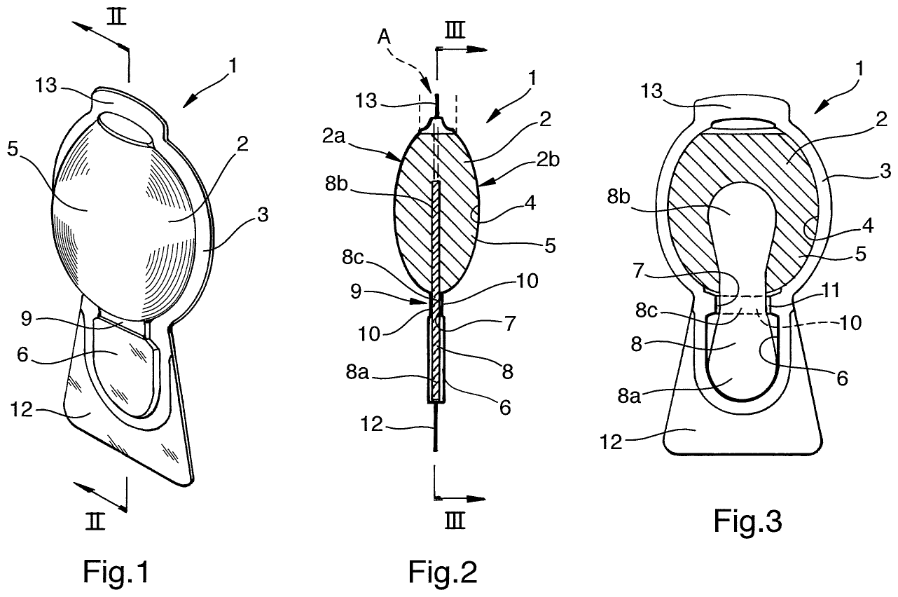

FIGS. 1 to 3 show the packaged product unit 1, that is, the product in its package 2. Package 2, which also functions as a mould, can be made of two opposing shells 2a, 2b, for example symmetrically opposed shells of any shape, preferably made of plastic.

Opposed shells 2a, 2b can be joined together by a continuous sealing 3, preferably hot sealing, along part of their outer edge, for example in the longitudinal median plane of the package 2.

The shells 2a, 2b define an inner cavity 4, with a pouch portion 5 which is large enough to hold the product. The inner cavity 4 also includes a pocket portion 6, adjacent to the pouch portion 5. Between the pouch portion 5 and the pocket portion 6, there is a passage 7 through which passes a handle 8, for example a stick, slat or similar. The handle 8 includes a grip portion 8a which is placed in the pocket portion 6 of the inner cavity 4. On the opposite side of the grip portion 8a, the handle 8 includes an anchor portion 8b which is placed in the pouch portion 5 of the inner cavity 4. The anchor portion 8b is incorporated into the solidified product so that it can be consumed in use by holding it from the grip portion 8a of the handle 8.

At passage 7 there is an intermediate sealing section 9 where the package 2 is in close contact with the handle 8 to prevent communication between the pouch portion 5 and the pocket portion 6 of the inner cavity 4. In particular, in the embodiment illustrated in the figures, the sealing section 9 is substantially transversal to the extension of the handle 8. The he sealing section 9 is preferably very short in the longitudinal direction, that is, in the direction of the length of the handle 8, so that it tightly seals only a limited, intermediate portion 8c of the handle 8 and leaves the grip portion 8a substantially free inside the pocket portion 6 of the inner cavity 4. The sealing section 9 includes two depressions 10 on the two shells 2a, 2b on both sides of the handle 8, so that the shells 2a, 2b rest against the flat surface of the handle 8. The sealing section 9 also includes two lateral junction zones 11 which reduce the width of the passage 7 to the width of the handle 8 in its intermediate zone 8c between the grip portion 8a and the anchor portion 8b, compared to the original width of passage 7 made wide enough to allow the introduction of the grip portion 8a into the pocket portion 6 of the inner cavity 4 of pack 2.

Outside the continuous sealing 3, the package 2 may have opening means in an opening zone 12. In the opening zone 12, the two opposing shells 2a, 2b which form the package 2 are not welded together. In the opening zone 12, two flaps are therefore formed that are next to each other but can be easily separated and can therefore be grasped and pulled away from each other by a user who wants to open the package 2 in order to consume the product. However, it must be understood that the opening means, preferably in the form of flaps, can be provided at any section of the continuous sealing 3.

In one section of the continuous sealing 3, on the opposite side of the opening zone 12, there is an upper section 13 of the continuous sealing 3. The upper section 13 of the seal is for example flat and is sealed after the fluid product has been introduced into the inner cavity 4 through an opening A, so that the package for packaged products 2 is finally completely sealed.

The handle 8 may include an elongated flat slat, such as the one shown in the figures, which may have a profile of any shape, and in particular may be wider in the grip portion 8a than in the intermediate area 8c which is placed in the passage 7.

To make the packaged product unit 1, the package 2 is prepared by sealing together two sheets of plastic material along the continuous seal 3 with the exception of the opening zone 12 which remains open to form opening A. At this stage, continuous sealing 3 may have a central narrowing portion which forms the passage 7. In any case, the passage 7 initially presents a width such that the grip portion 8a of the handle 8 can be easily inserted into the pocket portion 6 of the inner cavity 4, after the latter has been formed for example by blowing air into the package 2 through opening A.

When the handle 8 is placed into the inner cavity 4, with its grip portion 8a placed in the pocket portion 6 and the anchor portion 8b placed in the pocket portion 5, the tightly sealing section 9 is made all around the intermediate area 8c of handle 8. The sealing section 9 is made by applying a hot compression, for example by means of heated plates or moulds configured for this purpose. After the sealing section 9 has been made, so that the passage 7 is completely occupied by the handle 8 and there is no more communication between the pouch portion 5 and the pocket portion 6, a fluid product is poured through the opening A to fill the pouch portion 5. The continuous sealing 3 is then completed with the closing of opening A by providing the upper sealing section 13. Materials can be selected in order to provide a welded seal between the package and the handle.

Naturally, without prejudice to the principle of the invention, the embodiments and the details of production may vary widely with respect to what has been described and illustrated, without leaving the scope of the present invention.

1. A method for packaging an edible product, comprising:
forming a package for packaged products comprising a pouch portion and a pocket portion, with a passage between the two portions,
inserting a handle in the passage so that it is arranged with a grip portion thereof in the pocket portion and with a different, anchor portion thereof in the pouch portion,
tightly sealing the package around the handle at, or adjacent to the passage, to make a tight seal between the pouch portion and the pocket portion,
filling the pouch portion with an edible fluid through an opening in the pouch portion of said package for packaged products, and
sealing said opening.

2. The method according to claim 1, wherein the package is sealed around an intermediate portion of the handle.

3. The method according to claim 1, wherein the package for packaged products is formed by joining together a pair of opposite shells, the sealing around the handle being carried out by hot compression of the two shells in a mould.

4. The method according to claim 3, wherein the opposite shells are sealed together in a separable manner along a peripheral edge.

5. The method according to claim 1, wherein the pouch portion and the pocket portion are formed by blow moulding.

6. A packaged product unit comprising a package for packaged products comprising a pouch portion and a pocket portion, with a passage between the two portions where a handle is introduced so that a grip portion thereof is disposed within the pocket portion and an anchor portion thereof is disposed within the pouch portion, an edible product being arranged in the pouch portion, an area of the package at, or adjacent to the passage being tightly sealed around the handle to make a tight seal between the pouch portion and the pocket portion.
